(19) United States
(12) Patent Application Publication
(10) Pub. No.: US 2019/0317372 A1
(43) Pub. Date: Oct. 17, 2019

(54) CURVED DISPLAY PANEL

(71) Applicant: InnoLux Corporation, Miao-Li County (TW)

(72) Inventors: Chia-Hao Tsai, Miao-Li County (TW); Ming-Jou Tai, Miao-Li County (TW); Yi-Shiuan Cherng, Miao-Li County (TW); Chang-Chiang Cheng, Miao-Li County (TW)

(21) Appl. No.: 16/362,715

(22) Filed: Mar. 25, 2019

(30) Foreign Application Priority Data
Apr. 13, 2018 (CN) 201810332503.7

(51) Int. Cl. G02F 1/1362; G02F 1/1368; G02F 1/1343; G02F 1/1335; G02F 1/1339

(52) U.S. Cl. CPC G02F 1/136209; G02F 1/136227; G02F 1/1368; G02F 1/136286; G02F 1/134363; G02F 1/13624; G02F 2001/13396; G02F 1/13394; G02F 2001/13685; G02F 2001/134345; G02F 2201/40; G02F 2201/56; G02F 1/133512

(57) ABSTRACT

The present disclosure provides a curved display panel including a bending axis parallel to a first direction. The curved display panel includes: a first substrate; a plurality of sub-pixels disposed on the first substrate, wherein each of the sub-pixels includes a longer edge and a shorter edge, the shorter edge is parallel to the first direction, the longer edge is parallel to a second direction, and the first direction and the second direction are not parallel; a plurality of first metal lines disposed on a surface of the first substrate and extending in the first direction, wherein each of the sub-pixels is disposed corresponding to one of the first metal lines; and a first black matrix layer disposed on the surface of the first substrate, the first black matrix layer overlapping the first metal lines in a normal direction of the surface of the first substrate.

### CROSS REFERENCE TO RELATED APPLICATION

This application claims priority of China Patent Application No. 201810332503.7, filed on Apr. 13, 2018. The entirety of the above-mentioned patent application is incorporated by reference herein and made a part of this specification.

### BACKGROUND OF THE DISCLOSURE

### 1. Field of the Disclosure

The present disclosure relates to a display panel, and more particularly, to a curved display panel.

### 2. Description of the Prior Art

In recent years, curved electronic devices have become the focus of the new generation of electronic technology. There is increasing demand for curved display panels which are capable of being integrated in curved electronic devices. Both small to medium-sized and large-sized curved display panels are major developing technologies. Components on two substrates in a conventional display panel will be shifted after the conventional display panel is curved, leading to color mixing or the Mura phenomenon.

### SUMMARY OF THE DISCLOSURE

In some embodiments, a curved display panel including a bending axis parallel to a first direction includes: a first substrate; a plurality of sub-pixels disposed on the first substrate, wherein each of the sub-pixels includes a longer edge and a shorter edge, the shorter edge is parallel to the first direction, the longer edge is parallel to a second direction, and the first direction and the second direction are not parallel; a plurality of first metal lines disposed on a surface of the first substrate and extending in the first direction, wherein each of the sub-pixels is disposed corresponding to one of the first metal lines; and a first black matrix layer disposed on the surface of the first substrate, the first black matrix layer overlapping the first metal lines in a normal direction of the surface of the first substrate.

In some embodiments, a curved display panel including a bending axis parallel to a first direction includes: a first substrate; a plurality of sub-pixels disposed on the first substrate, wherein each of the sub-pixels includes a longer edge and a shorter edge, the shorter edge is parallel to the first direction, the longer edge is parallel to a second direction, and the first direction and the second direction are not parallel; a plurality of first metal lines disposed on a surface of the first substrate and extending in the first direction, wherein each of the sub-pixels is disposed corresponding to one of the first metal lines; and a first black matrix layer disposed between the first substrate and the second substrate, wherein the first black matrix layer includes a plurality of first black matrix patterns extending in the first direction, and one of the first black matrix patterns overlaps two adjoining first metal lines in the normal direction.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram illustrating a top view of a curved display device according to a first embodiment of the present disclosure.

FIG. 2 is a schematic diagram illustrating a top view of the structure of a portion of sub-pixels of the curved display device according to the first embodiment of the present disclosure.

FIG. 3 is a schematic diagram illustrating partial enlargement of a region R1 in FIG. 2.

FIG. 4 is a cross-sectional diagram taken along a line A-A′ in FIG. 3.

FIG. 5 is a cross-sectional diagram taken along a line B-B′ in FIG. 2.

FIG. 6 is a schematic diagram illustrating a top view of the structure of a portion of sub-pixels of the curved display device according to a second embodiment of the present disclosure.

FIG. 7 is a cross-sectional diagram taken along a line C-C′ in FIG. 6.

FIG. 8 is a schematic diagram illustrating a top view of the structure of a portion of sub-pixels of the curved display device according to a third embodiment of the present disclosure.

FIG. 9 is a schematic diagram illustrating the partial enlargement of a region R2 in FIG. 8.

FIG. 10 is a cross-sectional diagram taken along a line D-D′ in FIG. 9.

FIG. 11 is a schematic diagram illustrating a top view of the structure of a portion of sub-pixels of the curved display device according to a fourth embodiment of the present disclosure.

FIG. 12 is a schematic diagram illustrating the partial enlargement of a region R3 in FIG. 11.

FIG. 13 is a cross-sectional diagram taken along a line E-E′ in FIG. 12.

FIG. 14 is a schematic diagram illustrating a top view of the structure of a portion of sub-pixels of the curved display device according to a fifth embodiment of the present disclosure.

FIG. 15 is a cross-sectional diagram taken along a line F-F′ in FIG. 14.

### DETAILED DESCRIPTION

The present disclosure may be understood by reference to the following detailed description, taken in conjunction with the drawings as described below. It is noted that, for purposes of illustrative clarity and ease of understanding by the readers, various drawings of this disclosure show a portion of the display device, and certain elements in various drawings may not be drawn to scale.

In addition, the number and dimension of each device shown in drawings are only illustrative and are not intended to limit the scope of the present disclosure.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include”, “comprise” and “have” are used in an open-ended fashion, and thus should be interpreted to mean “include, but not limited to... ”.

It will be understood that when an element or layer is referred to as being “on” or “connected to” another element or layer, it may be directly on or directly connected to the other element or layer, or intervening elements or layers may be present (indirectly). In contrast, when an element is referred to as being “directly on” or “directly connected to” another element or layer, there are no intervening elements or layers present.

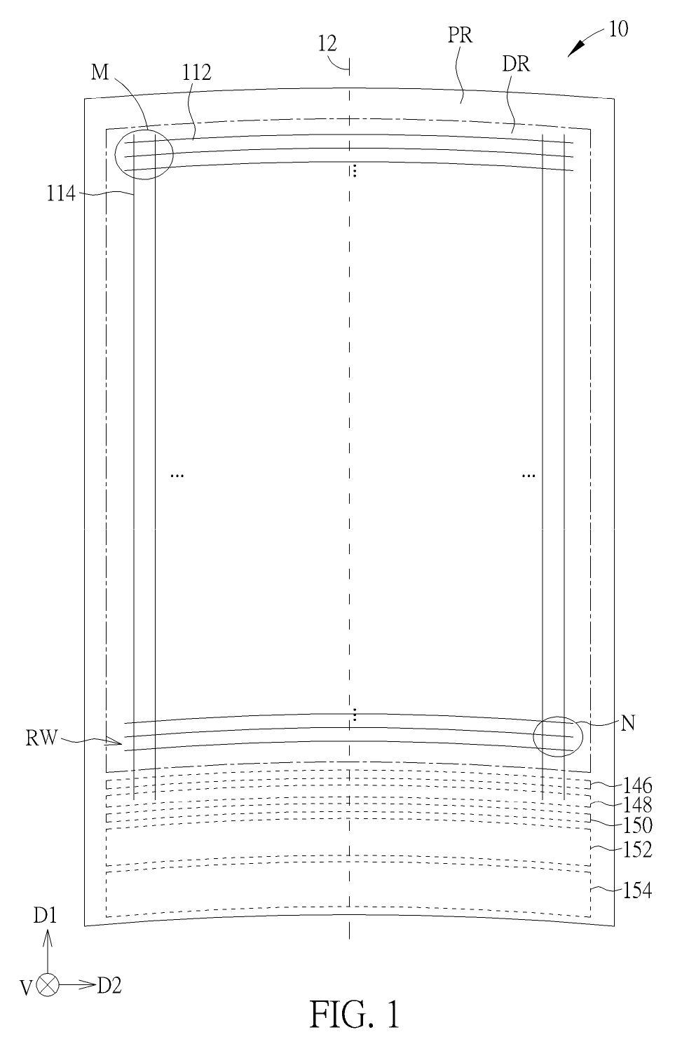

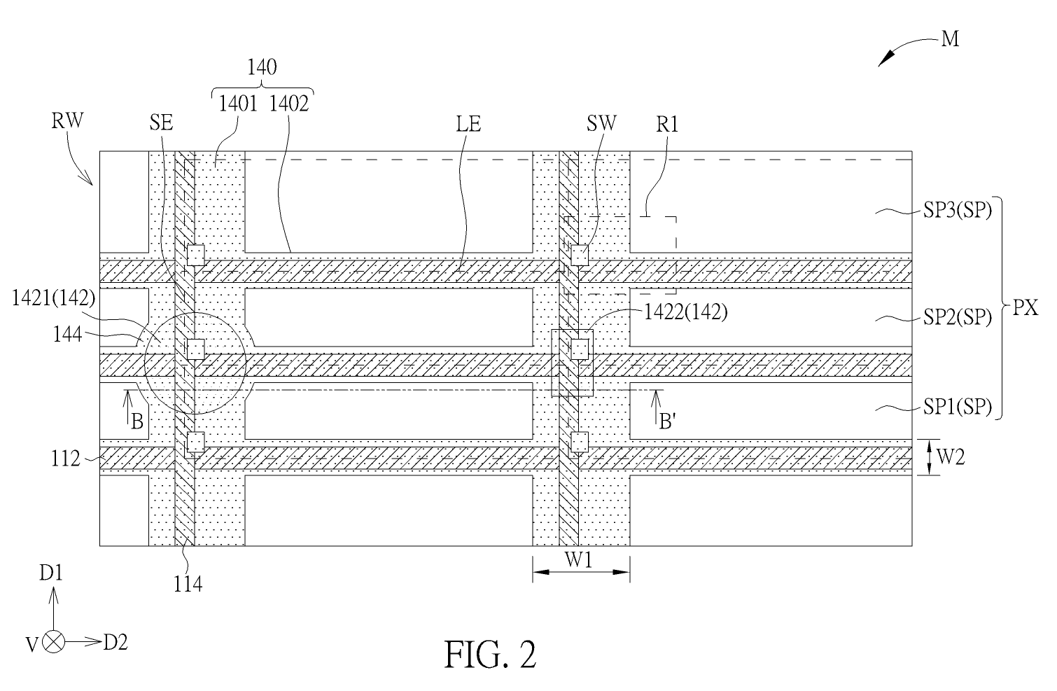

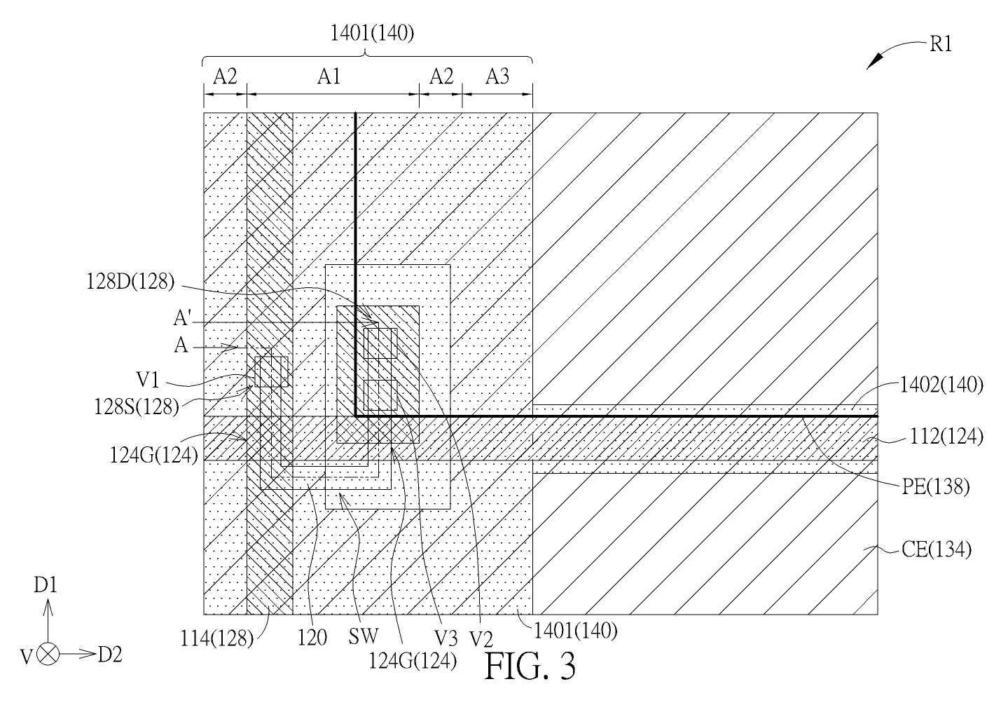

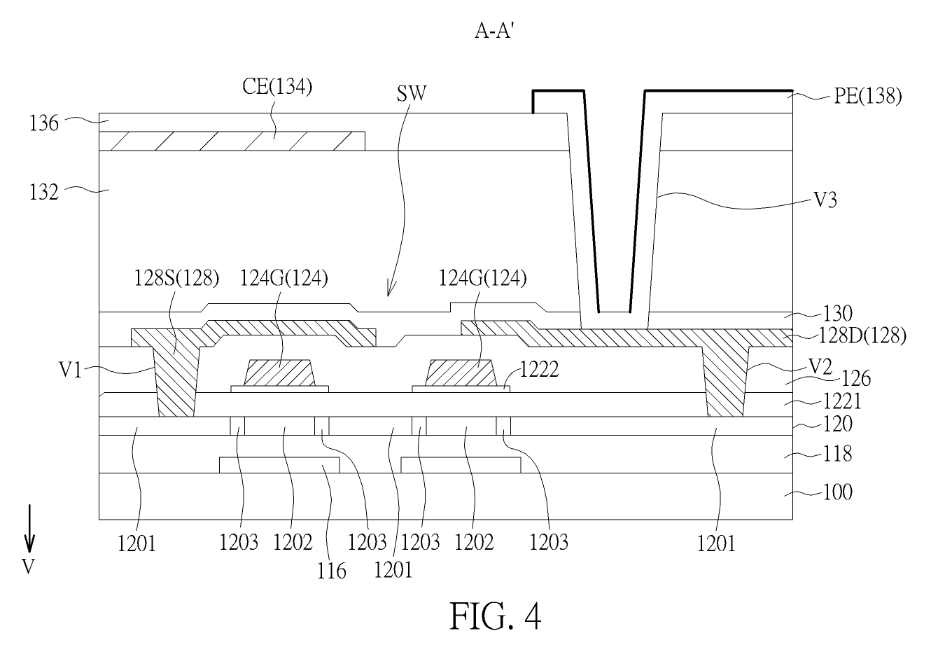

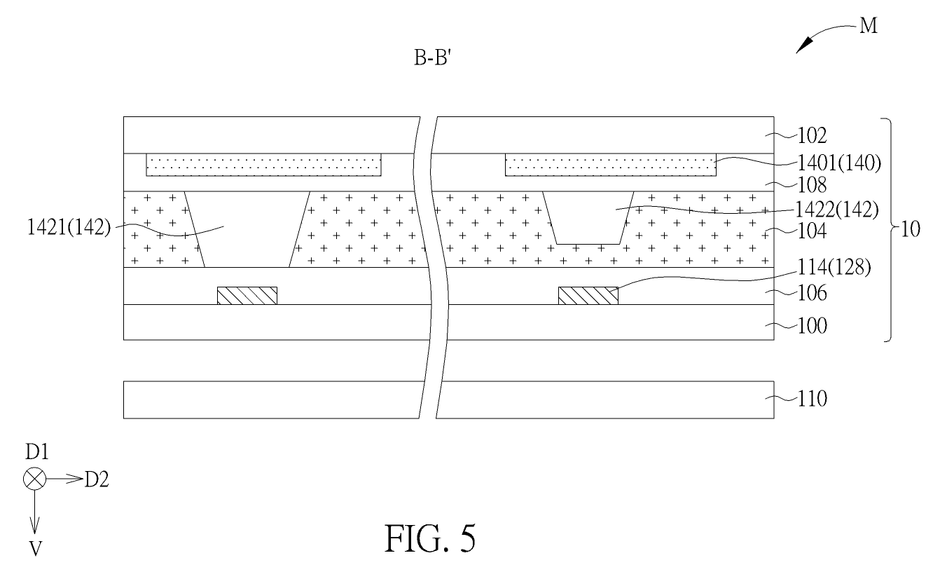

Referring to FIG. 1 to FIG. 5, FIG. 1 is a schematic diagram illustrating a top view of a curved display device according to a first embodiment of the present disclosure, FIG. 2 is a schematic diagram illustrating a top view of the structure of a portion of sub-pixels of the curved display device according to the first embodiment of the present disclosure, FIG. 3 is a schematic diagram illustrating partial enlargement of a region R1 in FIG. 2, FIG. 4 is a cross-sectional diagram taken along a line A-A′ in FIG. 3, and FIG. 5 is a cross-sectional diagram taken along a line B-B′ in FIG. 2. FIG. 4 and FIG. 5 are simplified schematic diagrams, wherein the display medium layer and devices on the second substrate are omitted in FIG. 4, and the backlight module is further illustrated in FIG. 5. The devices shown in FIG. 4 and FIG. 5 do not illustrate the curved structures, although the devices in FIG. 4 and FIG. 5 can include the curved structures according to FIG. 1. As shown in FIG. 1, a curved display panel 10 of this embodiment includes a bending axis 12 parallel to a first direction D1. For example, the bending axis 12 can pass through the center of the curved display panel 10, a virtual axis parallel to the bending axis 12 can also be set as a bending axis, and two portions of the curved display panel 10 corresponding to two sides of the bending axis 12 can be bent or curved according to the virtual axis or the bending axis 12; that is, the two portions of the curved display panel 10 can be bent or curved along a normal direction V perpendicular to the surface of the curved display panel 10, but the embodiment is not limited thereto. The location or the direction of the bending axis 12 is not limited to the content in FIG. 1; the bending axis 12 can be defined at different locations in the curved display panel 10 according to different requirements or designs. Further, the two portions of the curved display panel 10 corresponding to two sides of the bending axis 12 can also be bent along a direction opposite to the normal direction V. The curved display panel 10 of this embodiment is a liquid crystal display panel, but is not limited thereto. The curved display panel 10 may also be other suitable types of display panels, such as a light-emitting diode (LED) display panel, micro LED or mini LED display panel, or organic light-emitting diode (OLED) display panel. It is noteworthy that the size (e.g. length or width) of the LED chip may be in a range from 300 μm (micrometer) to 10 mm (millimeter), the size of the mini LED chip may be in a range from 100 μm to 300 μm, and the size of the micro LED chip may be in a range from 1 μm to 100 μm. As shown in FIG. 5, the curved display panel 10 includes a first substrate 100, a second substrate 102, and a display medium layer 104. The second substrate 102 is disposed opposite to the first substrate 100, and the display medium layer is disposed between the second substrate 102 and the first substrate 100. The first substrate 100 and the second substrate 102 can be rigid substrates, such as glass substrates, silicon substrates, or sapphire substrates. The first substrate 100 and the second substrate 102 can also be bendable or deformable substrates, such as plastic substrates formed of PI (polyimide), PET (polyethylene terephthalate), PC (polycarbonates), or PMMA (poly (methyl methacrylate)). The display medium layer 104 can be a liquid crystal layer or an LED, but is not limited thereto. The curved display panel 10 can further include a switch device layer 106 and a color filter layer 108. The switch device layer 106 is disposed between the first substrate 100 and the display medium layer 104. The color filter layer 108 is disposed between the second substrate 102 and the display medium layer 104. Additionally, the curved display panel 10 of this embodiment and a backlight module 110 can form a curved display device. The backlight module 110 can include at least one light source enabling the backlight module 110 to provide light to the curved display panel 10, and the light can be used by the curved display panel 10 to display images. Similar to the aforementioned curved display panel 10, the backlight module 110 can also include the curved structure.

As shown in FIG. 1, a display region DR and a peripheral region PR are defined in the curved display panel 10, the peripheral region PR is disposed on a side of the display region DR, and the peripheral region PR of this embodiment surrounds the display region DR, but this is not limited thereto. The curved display panel 10 includes a plurality of scan lines 112 and a plurality of data lines 114 disposed on the surface of the first substrate 100. The scan lines 112 and the data lines 114 can be disposed in the switch device layer 106 (as shown in FIG. 5), and the scan lines 112 and the data lines 114 are at least disposed in the display region DR. The scan lines 112 extend in a second direction D2, the data lines 114 extend in the first direction D1, and the data lines 114 are parallel to the bending axis 12. The first direction D1 and the second direction D2 are not parallel, thus the scan lines 112 cross the data lines 114 to form a web structure. In this embodiment, the first direction D1 is perpendicular to the second direction D2, and the normal direction V is perpendicular to both the first direction D1 and the second direction D2, but this is not limited thereto. The scan lines 112 and the data lines 114 of this embodiment can be formed of different patterned metal layers. In the first embodiment to the fourth embodiment, the data lines 114 can be the first metal lines as referred to in the claims, and the scan lines 112 can be the second metal lines referred to in the claims. In the fifth embodiment, the scan lines 112 can be the first metal lines referred to in the claims, and the data lines 114 can be the second metal lines referred to in the claims.

As shown in FIG. 2, the curved display panel 10 includes a plurality of sub-pixels SP disposed in the display region DR and on the first substrate 100. The areas of the sub-pixels SP are substantially defined by the data lines 114 and the scan lines 112. FIG. 2 illustrates the structure of a portion of the sub-pixels SP in the display region DR in FIG. 1, such as the structure of a portion M of the sub-pixels SP in the display region DR in FIG. 1. Specifically, the scan lines 112 and the data lines 114 cross each other and form a plurality of rectangular regions, wherein each of the sub-pixels SP corresponds to one of the rectangular regions, and the outline of each sub-pixel SP is substantially the same as the outline of the corresponding rectangular region. Each of the sub-pixels SP is disposed corresponding to one of the scan lines 112 and one of the data lines 114. Each of the sub-pixels SP includes a longer edge LE and a shorter edge SE, the shorter edge SE is parallel to the first direction D1, and the longer edge LE is parallel to the second direction D2. Accordingly, the extending direction of the longer edge LE of each of the sub-pixels SP is perpendicular to the bending axis 12. In this embodiment, the longer edge LE is parallel to the corresponding scan line 112 and extends in the middle of the corresponding scan line 112, but is not limited thereto. For example, the longer edge LE can be located at half the width of the corresponding scan line 112. Additionally, the shorter edge SE is parallel to the corresponding data line 114 and extends in the middle of the corresponding data line 114, but is not limited thereto. For example, the shorter edge SE can be located at half the width of the corresponding data line 114. The sub-pixels SP in this embodiment include a plurality of first sub-pixels SP1, a plurality of second sub-pixels SP2, and a plurality of third sub-pixels SP3. The first sub-pixels SP1, the second sub-pixels SP2, and the third sub-pixels SP3 are configured to display different colors. For example, the first sub-pixels SP1 may display red light, the second sub-pixels SP2 may display blue light, and the third sub-pixels SP3 may display green light, but this is not limited thereto. In addition, the sub-pixels SP are arranged in a plurality of sub-pixel rows RW extending in the second direction D2. In the sub-pixel rows RW, the sub-pixels SP in the same sub-pixel row RW display the same color. The sub-pixels SP in the same sub-pixel row RW may all be the first sub-pixels SP1, the second sub-pixels SP2, or the third sub-pixels SP3. In addition, the curved display panel 10 of this embodiment includes a plurality of pixels PX, wherein each pixel PX can be formed of one first sub-pixel SP1, one second sub-pixel SP2, and one third sub-pixel SP3. In one of the pixels PX, the first sub-pixel SP1, the second sub-pixel SP2, and the third sub-pixel SP3 are sequentially disposed adjoining each other in the first direction D1, and the second sub-pixel SP2 is disposed between the first sub-pixel SP1 and the third sub-pixel SP3. Each of the sub-pixels SP includes a switch device SW (shown in FIG. 3 and FIG. 4), and the switch device SW is electrically connected to one scan line 112 and one data line 114 corresponding to that sub-pixel SP. In one of the pixels PX, the switch devices SW of the first sub-pixel SP1, the second sub-pixel SP2, and the third sub-pixel SP3 are electrically connected to different scan lines 112, and the switch devices SW of the first sub-pixel SP1, the second sub-pixel SP2, and the third sub-pixel SP3 are all electrically connected to the same data line 114. Therefore, each of the pixels PX corresponds to three scan lines 112 and one data line 114.

FIG. 3 and FIG. 4 illustrate one of the switch devices SW shown in FIG. 2. As shown in FIG. 3 and FIG. 4, the curved display panel 10 of this embodiment includes a patterned shielding layer 116, a buffer layer 118, a patterned semiconductor layer 120, a first gate insulating layer 1221, a second gate insulating layer 1222, a first patterned metal layer 124, a first insulating layer 126, a second patterned metal layer 128, a second insulating layer 130, a third insulating layer 132, a first patterned transparent conductive material layer 134, a fourth insulating layer 136, and a second patterned transparent conductive material layer 138. The patterned shielding layer 116, the buffer layer 118, and some of the insulating layers are selectively disposed and may be omitted in the curved display panel 10. The aforementioned layers are disposed on the first substrate 100 and form the switch device layer 106 in FIG. 5. The patterned semiconductor layer 120 in this embodiment includes a U-shaped structure, and the material of the patterned semiconductor layer 120 is polysilicon, but is not limited thereto. The material of the patterned semiconductor layer 120 may be other suitable semiconductor materials, such as amorphous silicon or metal oxides (e.g. indium gallium zinc oxide (IGZO)). The patterned semiconductor layer 120 includes three heavily doped regions 1201, two channel regions 1202, and four lightly doped regions 1203. Each of the channel regions 1202 is disposed between two heavily doped regions 1201, and each of the lightly doped regions 1203 is disposed between one channel region 1202 and one heavily doped region 1201. Two heavily doped regions 1201 are disposed at two ends of the patterned semiconductor layer 120 and serve as the drain doped region and the source doped region. The doped regions in the patterned semiconductor layer 120 of this embodiment are N- type doped regions, but this is not limited thereto. In other embodiments, the doped regions in the patterned semiconductor layer 120 may also be P-type doped regions. In addition, the patterned shielding layer 116 and the buffer layer 118 are disposed between the patterned semiconductor layer 120 and the first substrate 100. The material of the patterned shielding layer 116 can include metal, but is not limited thereto. The patterned shielding layer 116 overlaps the channel regions 1202 and the lightly doped regions 1203 in the normal direction V perpendicular to the surface of the first substrate 100, to prevent the performance of the channel regions 1202 and the lightly doped regions 1203 from being degraded by light.

The first gate insulating layer 1221 is disposed on the patterned semiconductor layer 120, the first patterned metal layer 124 is disposed on the first gate insulating layer 1221, and the second gate insulating layer 1222 is disposed between the first patterned metal layer 124 and the first gate insulating layer 1221. The first gate insulating layer 1221 may be silicon oxide, but is not limited thereto. The second gate insulating layer 1222 may be a patterned insulating layer, and the material of the second gate insulating layer 1222 can include silicon nitride, but is not limited thereto. The first patterned metal layer 124 includes at least one gate 124G and gate line (scan line) 112, and the gate 124G is electrically connected to the gate line 112. In this embodiment, each switch device SW includes two gates 124G, and each gate 124G partially overlaps one corresponding channel region 1202 in the normal direction V. The first insulating layer 126 is disposed on the first patterned metal layer 124, and the second patterned metal layer 128 is disposed on the first insulating layer 126. The second patterned metal layer 128 includes at least one source contact 128S, at least one drain contact 128D, and the data lines 114. The source contact 128S connects the heavily doped region 1201 at one end of the patterned semiconductor layer 120 through a contact hole V1, and the drain contact 128D connects the heavily doped region 1201 at another end of the patterned semiconductor layer 120 through a contact hole V2. The heavily doped region 1201 that is in contact with the source contact 128S serves as a source, and the heavily doped region 1201 that is in contact with the drain contact 128D serves as a drain. The contact hole V1 and the contact hole V2 penetrate the first insulating layer 126 and the first gate insulating layer 1221. The data line 114 directly and electrically connects to the source contact 128S. The materials of the first patterned metal layer 124 and the second patterned metal layer 128 include molybdenum (Mo), aluminum (Al), titanium (Ti), copper (Cu), or other metallic materials. In other embodiments, the first patterned metal layer 124 and the second patterned metal layer 128 can also be formed of transparent conductive materials.

The second insulating layer 130 is disposed on the second patterned metal layer 128, and the third insulating layer 132 is disposed on the second insulating layer 130, wherein the thickness of the third insulating layer 132 is greater than thicknesses of other insulating layers. The first patterned transparent conductive material layer 134 is disposed on the third insulating layer 132, and the first patterned transparent conductive material layer 134 includes at least one common electrode CE. The fourth insulating layer 136 is disposed on the first patterned transparent conductive material layer 134, the second patterned transparent conductive material layer 138 is disposed on the fourth insulating layer 136, wherein each sub-pixel SP includes a pixel electrode PE, and at least one of the pixel electrodes PE can be formed of the second patterned transparent conductive material layer 138. Each pixel electrode PE electrically connects to the corresponding drain contact 128D through a contact hole V3, wherein the contact hole V3 penetrates the second insulating layer 130, the third insulating layer 132, and the fourth insulating layer 136. The materials of the first insulating layer 126 to the fourth insulating layer 136 and the buffer layer 118 may be organic or inorganic insulating materials. The inorganic insulating materials can be silicon oxide, silicon nitride, or silicon oxynitride. The organic insulating materials can be polyimide (PI) or acrylic resin. The first patterned transparent conductive material layer 134 and the second patterned transparent conductive material layer 138 can be indium tin oxide (ITO) or indium zinc oxide (IZO), but are not limited thereto. In other embodiments, the pixel electrodes PE can be formed of the first patterned transparent conductive material layer 134, and the common electrodes CE can be formed of the second patterned transparent conductive material layer 138.

As shown in FIG. 2 and FIG. 5, the curved display panel 10 further includes a black matrix layer 140 disposed on the surface of the second substrate 102 and between the display medium layer 104 and the second substrate 102. Further, as shown in FIG. 2 and FIG. 3, the black matrix layer 140 in the portion M of the display region DR includes a plurality of black matrix pattern columns 1401 and a plurality of black matrix pattern rows 1402. Each of the black matrix pattern columns 1401 extends along one of the data lines 114 and overlaps the corresponding data line 114 in the normal direction V, and each of the black matrix pattern rows 1402 extends along one of the scan lines 112 and overlaps the corresponding scan line 112 in the normal direction V. The extending direction of the black matrix pattern columns 1401 of this embodiment is parallel to the bending axis 12. The width W1 of each of the black matrix pattern columns 1401 in the second direction D2 is greater than the width W2 of each of the black matrix pattern rows 1402 in the first direction D1. The width W1 can be the width of a portion of one of the black matrix pattern columns 1401 that does not include an auxiliary pattern 144, or the width of a portion of one of the black matrix pattern columns 1401 that is not located corresponding to a main spacer 1421. The auxiliary pattern 144 and the main spacer 1421 will be detailed in the paragraphs below. The width W1 of one of the black matrix pattern columns 1401 may be about 27 micrometers, and the width W2 of one of the black matrix pattern rows 1402 may be about 5 micrometers. It is noteworthy that the examples of completely overlapping and partially overlapping are both included in each embodiment of this disclosure. Also, it is noteworthy that the black matrix layer is used to block light from passing through. Therefore, the material of the black matrix layer is not particularly limited and can be one of the organic, inorganic or metal material. The optical density of the black matrix layer may be preferably greater than 2, but the present disclosure is not limited thereto.

In addition, as shown in FIG. 3, each of the black matrix pattern columns 1401 includes one first region A1, two second regions A2, and one third region A3 extending in the first direction D1. The first region A1 is disposed between two second regions A2, the third region A3 is disposed at one side of the first region A1, and one of the second regions A2 is disposed between the first region A1 and the third region A3. The range of the first region A1 in the second direction D2 can be from the left edge of the data line 114 of the second patterned metal layer 128 to the right edge of the drain contact 128D of the second patterned metal layer 128. Accordingly, the first region A1 of each of the black matrix pattern columns 1401 in this embodiment overlaps the corresponding data line 114 and the switch device SW electrically connected to the corresponding data line 114. According to this disclosure, the width of the first region A1 is greater than the widths of the second regions A2 and the third region A3, and the width of the third region A3 is greater than the widths of the second regions A2. For example, the width of the first region A1 is about 17 micrometers, the widths of the second regions A2 are about 3 micrometers, and the width of the third region A3 is about 4 micrometers in the second direction D2. In the assembling process of the curved display panel 10, the second regions A2 disposed at both sides of the first region A1 can ensure that each of the black matrix pattern columns 1401 can still overlap the corresponding data line 114 and the switch device SW electrically connected to the corresponding data line 114 when the alignment of the first substrate 100 and the second substrate 102 is inaccurate. Generally, in the portions of the curved display panel 10 located at two sides of the bending axis 12 in the second direction D2, the positions of the black matrix pattern columns 1401 disposed on the second substrate 102 and the positions of the data lines 114 disposed on the first substrate 100 will shift or be misaligned after the panel is bent. Therefore, the third region A3 can ensure that each of the black matrix pattern columns 1401 can still overlap the corresponding data line 114 and the switch device SW electrically connected to the corresponding data line 114 after misalignment occurs, thus the uniformity of the aperture ratios of the sub-pixels SP can be maintained or the Mura phenomenon caused by the exposed data lines 114 can be effectively reduced. In addition, the third region A3 can be disposed at one side of the first region A1 according to the direction or the movement of each of the black matrix pattern columns 1401 that shifts relative to the corresponding data line 114.

Table 1 illustrates the width W1 of each black matrix pattern columns 1401, the width W2 of each black matrix pattern rows 1402, and the aperture ratio of each sub-pixels SP in the curved display panels of the comparative example 1, the comparative example 2, and this embodiment. Referring to the pixel structure of this embodiment shown in FIG. 2, the differences between the comparative example 1 and this embodiment are that the longer edge LE of each sub-pixel SP is parallel to the first direction D1 and the bending axis 12, each pixel PX is formed of three sub-pixels SP sequentially disposed adjoining each other in the second direction D2, and each pixel PX includes three data lines 114 extending in the first direction D1 and one scan line 112 extending in the second direction D2. In each of the pixels PX, the switch device SW of each sub-pixel SP is electrically connected to one of three data lines 114, and the switch devices SW of three sub-pixels SP are electrically connected to the same scan line 112. In the comparative example 1, each black matrix pattern column 1401 overlaps one corresponding data line 114, and the width W1 of each black matrix pattern column 1401 is about 5 micrometers. Additionally, each black matrix pattern row 1402 overlaps one corresponding scan line 112 and the switch device SW electrically connected to this scan line 112, and the width W2 of each black matrix pattern row 1402 is about 15 micrometers. The positions of the black matrix pattern columns 1401 and the corresponding data lines 114 will shift and be misaligned after the curved display panel in the comparative example 1 is bent, and the black matrix pattern columns 1401 cannot overlap the corresponding data lines 114, thus the data lines 114 are exposed. Therefore, problems such as poor uniformity of aperture ratios or Mura may occur in the curved display panel of the comparative example 1. In order to solve problems of the curved display panel of the comparative example 1, the width of each black matrix pattern column 1401 is increased in the curved display panel of the comparative example 2, and the width W1 of each black matrix pattern column 1401 can be about 13 micrometers. Accordingly, the black matrix pattern columns 1401 can still overlap the corresponding data lines 114 even when the black matrix pattern columns 1401 and the corresponding data lines 114 are misaligned. Each pixel PX in the comparative example 2 includes three black matrix pattern columns 1401, and each black matrix pattern column 1401 is parallel to the longer edge of the sub-pixel SP, thus the aperture ratio of each sub-pixel SP will be dramatically reduced when the width of each black matrix pattern column 1401 is increased. As shown in Table 1, the aperture ratio of each sub-pixel SP in the comparative example 1 is 58.17%, the aperture ratio of each sub-pixel SP in the comparative example 2 is 29.09%, and the aperture ratio of each sub-pixel SP in the comparative example 2 is lowered about 50% relative to the comparative example 1. In the curved display panel 10 of this embodiment, each pixel PX includes one black matrix pattern column 1401, and the black matrix pattern column 1401 is parallel to the shorter edge of the sub-pixel SP, thus the phenomenon of poor uniformity of aperture ratios or Mura can be reduced, or the loss of the aperture ratio of each sub-pixel SP can be decreased when the width of each black matrix pattern column 1401 of this embodiment is increased. As shown in Table 1, the aperture ratio of each sub-pixel SP in the comparative example 1 is 58.17%, the aperture ratio of each sub-pixel SP in this embodiment is 43.06%, and the aperture ratio of each sub-pixel SP in this embodiment is lowered about 25.5% relative to the comparative example 1.

TABLE 1

| | Comparative | Comparative | First |
|---|---|---|---|
| | example 1 | example 2 | embodiment |
| W1 (micrometer) | 5 | 13 | 27 |
| W2 (micrometer) | 15 | 15 | 5 |
| Aperture ratio of | 58.17 | 29.09 | 43.36 |
| sub-pixel (%) | | | |

Further, as shown in FIG. 2 and FIG. 5, the sub-pixels SP in the same sub-pixel row RW display the same color in this embodiment; that is, the color filter layer 108 in FIG. 5 has the same color. Accordingly, even when the black matrix pattern columns 1401 cannot completely block the light from the adjacent sub-pixels SP when the black matrix pattern columns 1401 shift relative to the corresponding data lines 114 in the second direction D2, the phenomenon of color mixing can still be prevented when the user is obliquely viewing the curved display panel 10 from the second direction D2.

In addition, the curved display panel 10 further includes at least one spacer 142 disposed between the first substrate 100 and the second substrate 102, wherein each spacer 142 can be disposed corresponding to one of the black matrix pattern columns 1401, and the black matrix pattern column 1401 overlaps the corresponding spacers 142 in the normal direction V. In the curved display panel 10, the spacers 142 include one or more main spacers 1421 and one or more sub-spacers 1422, and the number of the main spacers 1421 is less than the number of the sub-spacers 1422. As shown in FIG. 5, the height of each main spacer 1421 is greater than the height of each sub-spacer 1422. For example, two ends of each of the main spacers 1421 can be in contact with a layer (for example, but not limited to, an alignment layer) disposed on the surface of the first substrate 100 and a layer (for example, but not limited to, an alignment layer) disposed on the surface of the second substrate 102, one end of each of the sub-spacers 1421 can be in contact with a layer disposed on the surface of the second substrate 102, and the above description includes the situations of direct contact and indirect contact. Additionally, a gap can be formed between another end of each of the sub-spacers 1421 and a layer disposed on the surface of the first substrate 100. As shown in FIG. 2, in the top view of the surface of the first substrate 100 (e.g. viewed from a direction perpendicular to the surface), the area of the main spacer 1421 is greater than the area of the sub-spacer 1421, the outline of the main spacer 1421 is circular and the outline of the sub-spacer 1422 is triangular. In other embodiments, the outline of the sub-spacer 1422 may also be circular. Since the size (e.g. area or height) of the main spacer 1421 is relatively large, each of the black matrix pattern columns 1401 includes at least one auxiliary pattern 144 disposed corresponding to the main spacer 1421 for overlapping the corresponding main spacer 1421. The width of the auxiliary pattern 144 is slightly greater than the width W1 of the black matrix pattern column 1401. In addition, each of the black matrix pattern columns 1401 has a larger width W1 in this embodiment, and therefore it is not required to further increase the width W1 of each of the black matrix pattern columns 1401 in order to overlap the corresponding sub-spacers 1422, and the loss of the aperture ratio of each sub-pixel SP caused by placing the sub-spacers 1422 can be reduced.

Referring to FIG. 1 again, the curved display panel 10 may selectively include a dummy pixel region 146, a demultiplexer (Demux) region 148, an electrostatic discharge (ESD) region 150, a fan-out region 152, and a bonding region 154 disposed in the peripheral region PR. The above regions can be disposed in a portion of the peripheral region PR by a side of the display region DR in the first direction D1. For example, the dummy pixel region 146, the Demux region 148, the ESD region 150, the fan-out region 152, and the bonding region 154 may be sequentially disposed in a portion of the peripheral region PR below the display region DR in a direction opposite to the first direction D1, but this is not limited thereto. The data lines 114 in the display region DR extend into the Demux region 148 along the direction opposite to the first direction D1, and the data lines 114 are electrically connected to the demultiplexers in the Demux region 148. Each pixel PX corresponds to one data line 114 in this embodiment, each pixel PX corresponds to three data lines 114 in the comparative example 1 or the comparative example 2, and therefore the number of the data lines 114 in the curved display panel 10 of this embodiment is about one third of the number of the data lines 114 in the comparative example 1 or the comparative example 2 with the same number of pixels. The curved display panel 10 in this embodiment can use one-to-two type of Demux (e.g. one conductive line connected to the driving IC is divided into two data lines 114) in the Demux region 148 when the curved display panel in the comparative example 1 or the comparative example 2 uses one-to-six type of Demux (e.g. one conductive line connected to the driving IC is divided into six data lines 114). Accordingly, the area of the Demux region 148 or the width of the border frame can be reduced. For example, the width of the Demux region in the comparative example 1 or the comparative example 2 is about 450 micrometers, and the width of a portion of the peripheral region PR below the display region DR is about 1.8 millimeters. In the curved display panel 10 of this embodiment, the width of the Demux region 148 is about 150 micrometers, and the width of a portion of the peripheral region PR below the display region DR is about 1.5 millimeters. Further, replacing the one-to-six type of Demux with the one-to-two type of Demux can decrease the manufacturing cost of the curved display panel 10. In other embodiments, the Demux can be omitted in the curved display panel 10 in this embodiment when the curved display panel in the comparative example 1 or the comparative example 2 uses one-to-three type of Demux (e.g. one conductive line connected to the driving IC is divided into three data lines 114) in the Demux region. Accordingly, the area of the Demux region 148 or the width of the border frame can be reduced. For example, the width of the Demux region in the comparative example 1 or the comparative example 2 is about 350 micrometers, and the width of a portion of the peripheral region PR below the display region DR is about 2 millimeters. In the curved display panel 10 of this embodiment, the Demux region 148 can be omitted, and the width of a portion of the peripheral region PR below the display region DR is about 1.65 millimeters, thus the manufacturing cost of the curved display panel 10 can be decreased.

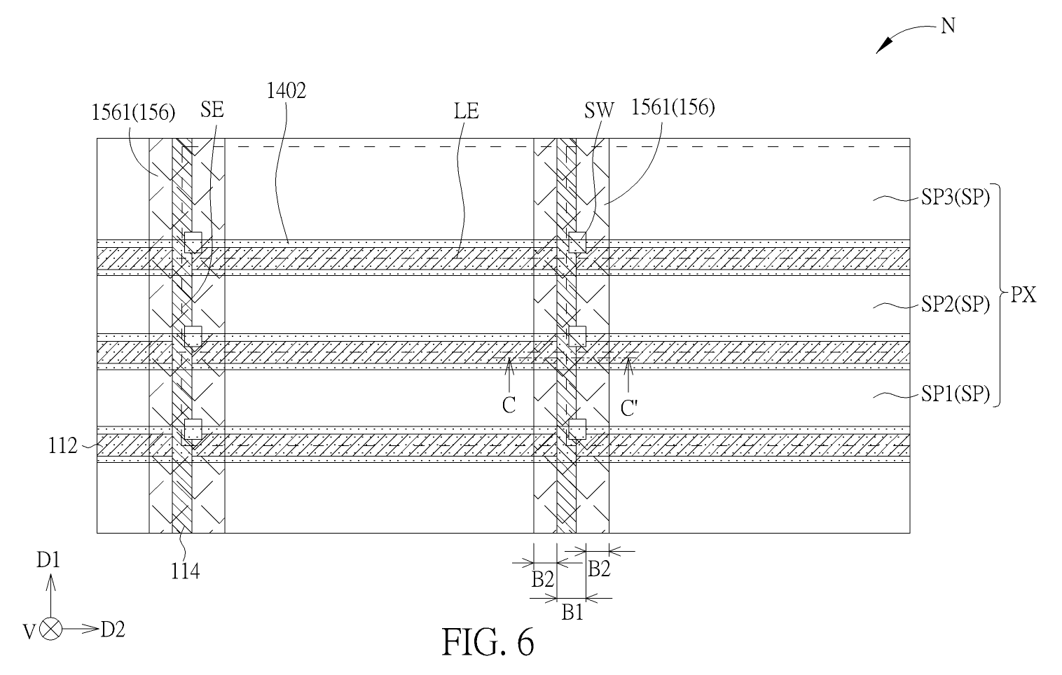

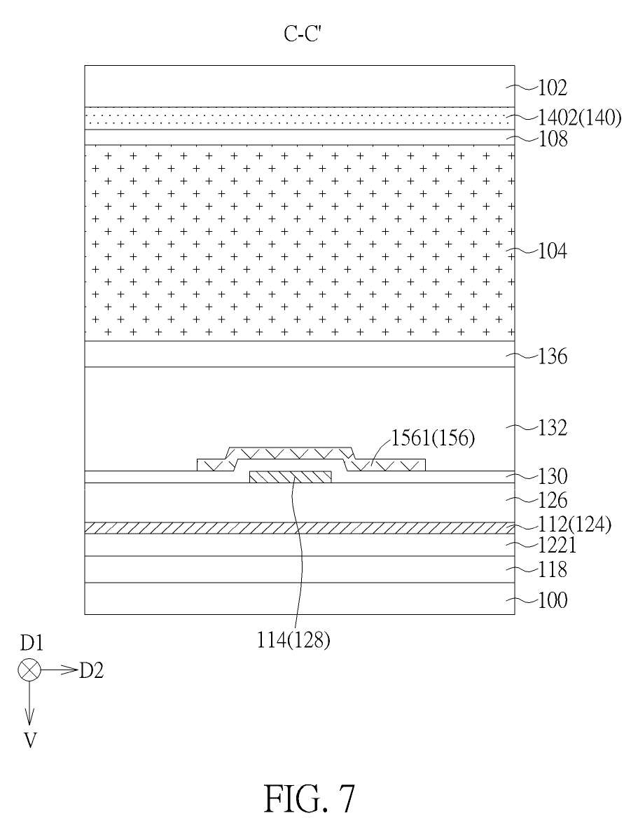

Referring to FIG. 6 and FIG. 7, FIG. 6 is a schematic diagram illustrating a top view of the structure of a portion of sub-pixels of the curved display device according to a second embodiment of the present disclosure, and FIG. 7 is a cross-sectional diagram taken along a line C-C′ in FIG. 6. FIG. 6 shows the structure of another portion in the display region DR in FIG. 1, such as the structure of a portion N in the display region DR in FIG. 1. It is noteworthy that the first and second embodiments in this disclosure are both described according to FIG. 1 for simplicity; the first embodiment and the second embodiment are not limited to be simultaneously practiced in the same curved display panel 10, but the present disclosure does not exclude the possibility of such an approach. As shown in FIG. 6 and FIG. 7, the curved display panel 10 further includes a first black matrix layer 156 disposed on the surface of the first substrate 100. In addition, the first black matrix layer 156 is disposed between the display medium layer 104 and the first substrate 100. For example, the first black matrix layer 156 is disposed between the second insulating layer 130 and the third insulating layer 132, but this is not limited thereto. In other embodiments, the first black matrix layer 156 may also be disposed between the fourth insulating layer 136 and the display medium layer 104.

The first black matrix layer 156 includes a plurality of first black matrix patterns 1561, and each of the first black matrix patterns 1561 extends in the first direction D1. Accordingly, each of the first black matrix patterns 1561 extends along one of the data lines 114 and overlaps the corresponding data line 114 in the normal direction V, and the extending direction of the first black matrix patterns 1561 is parallel to the bending axis 12. The data lines 114 overlapped by the first black matrix patterns 1561 described above can be the first metal lines in the claims.

As shown in FIG. 6, each of the first black matrix patterns 1561 includes a first region B1 and two second regions B2 extending in the first direction D1, wherein the first region B1 is disposed between the second regions B2, and the width of the first region B1 is greater than the widths of the second regions B2. The characteristics of the first region B1 of each of the first black matrix patterns 1561 may be the same as that of the first region Al of each of the black matrix pattern columns 1401, and the first region B1 of each of the first black matrix patterns 1561 overlaps the corresponding data line 114 and the switch device SW electrically connected to the corresponding data line 114. Generally, misalignment may occur during the process of forming the first black matrix patterns 1561, thus the design of disposing the second regions B2 at both sides of the first region B1 in the present disclosure can ensure that each of the first black matrix patterns 1561 can still overlap the corresponding data line 114 and the switch device SW electrically connected to the corresponding data line 114 after the first black matrix patterns 1561 are formed. The first black matrix patterns 1561 and the corresponding data lines 114 or switch devices SW are all disposed on the first substrate 100. Therefore, misalignments between the first black matrix patterns 1561 and the corresponding data lines 114 or switch devices SW in the second direction D2 can be effectively reduced after the curved display panel 10 is bent. Additionally, the phenomenon of poor uniformity of the aperture ratios of the sub-pixels SP or Mura caused by the exposed data lines 114 can be effectively reduced after the curved display panel 10 is bent. In the portion N of the display region DR, each of the scan lines 112 can be overlapped by a black matrix pattern row 1402 of the second black matrix layer 140, but this is not limited thereto. In other embodiments, the black matrix patterns overlapping the scan lines 112 in the portion N may also be formed of the first black matrix layer 156. Additionally, the design of the portion M in the first embodiment or the design of the portion N in the second embodiment maybe applied to the entire display region DR in other embodiments.

The following description will detail the different embodiments of the present disclosure. To simplify the description, identical components in each of the following embodiments are marked with identical symbols. For ease of understanding the differences between the embodiments, the following description will only detail the differences and identical features will not be redundantly described.

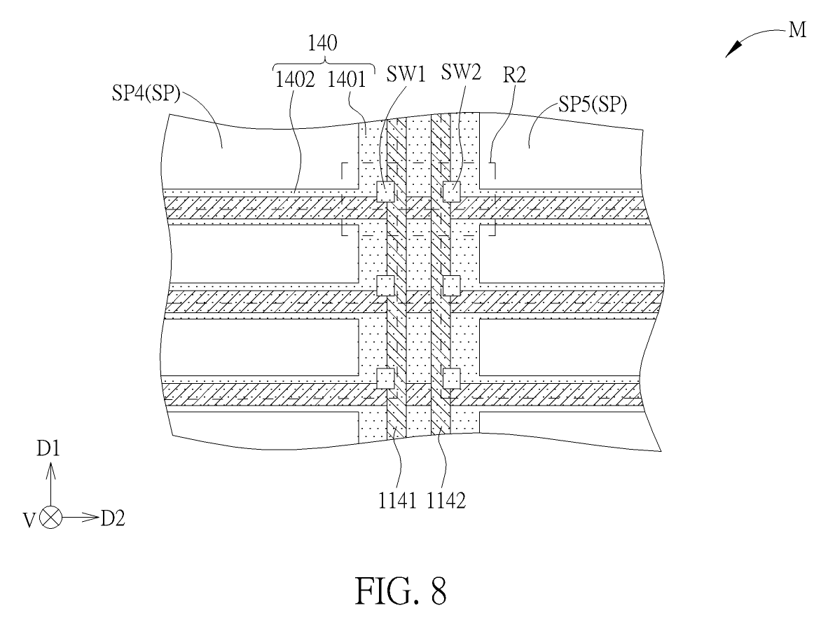

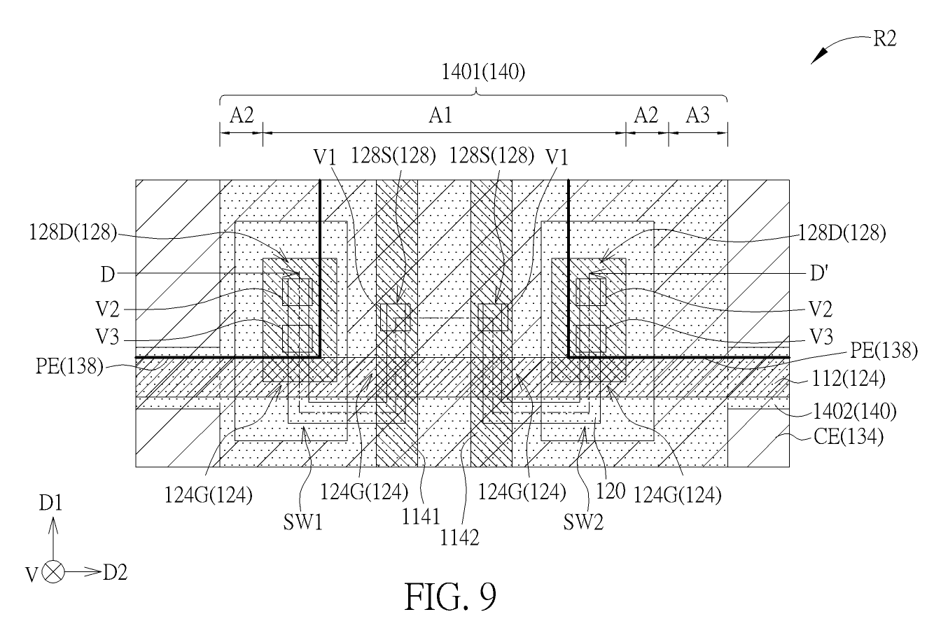

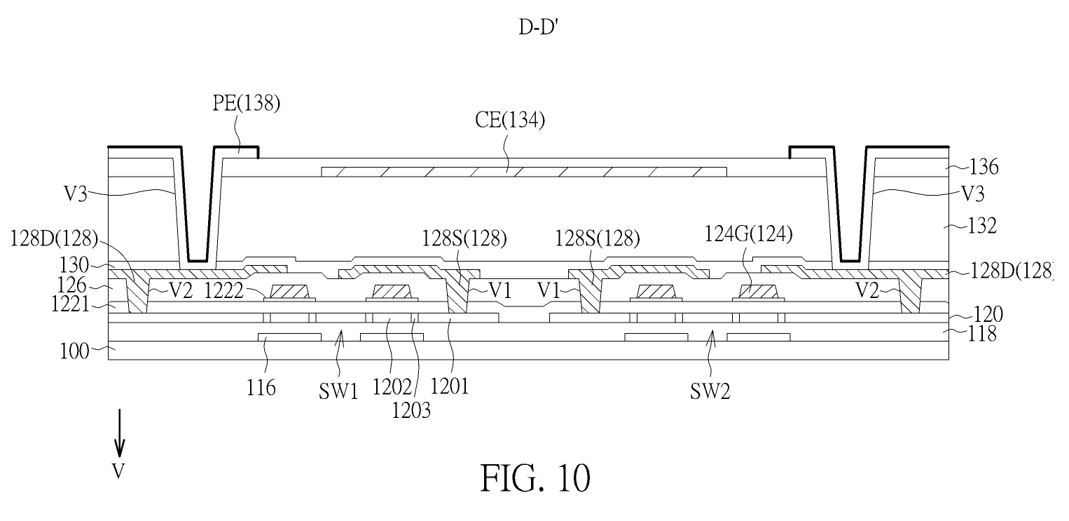

Referring to FIG. 8 to FIG. 10, FIG. 8 is a schematic diagram illustrating a top view of the structure of a portion of sub-pixels of the curved display device according to a third embodiment of the present disclosure, FIG. 9 is a schematic diagram illustrating the partial enlargement of a region R2 in FIG. 8, and FIG. 10 is a cross-sectional diagram taken along a line D-D′ in FIG. 9. The difference between the first embodiment and this embodiment is that two data lines 114 corresponding to two adjoining sub-pixels SP in the second direction D2 are disposed adjoining each other. As shown in FIG. 8, in the portion M in the curved display panel 10 of this embodiment, a sub-pixel SP4 and a sub-pixel SP5 are disposed adjoining each other in the second direction D2, and the sub-pixel SP4 and the sub-pixel SP5 can be disposed in the same pixel row. The sub-pixel SP4 includes a first switch device SW1, and the first switch device SW1 is electrically connected to a data line 1141. The sub-pixel SP5 includes a second switch device SW2, and the second switch device SW2 is electrically connected to another data line 1142. The data line 1141 and the data line 1142 are disposed adjoining each other, and the data line 1141 and the data line 1142 are disposed between the first switch device SW1 and the second switch device SW2. In addition, one black matrix pattern column 1401 simultaneously overlaps the data line 1141, the data line 1142, and the switch devices SW electrically connected to the data line 1141 and the data line 1142 in the normal direction V. Each of the black matrix pattern rows 1402 overlaps the corresponding scan line 112 in the normal direction V.

FIG. 9 illustrates the first switch device SW1 and the second switch device SW2 in FIG. 8. As shown in FIG. 9 and FIG. 10, the source contact 128S of the first switch device SW1 is connected to the data line 1141, the source contact 128S of the second switch device SW2 is connected to the data line 1142, and the data line 1141 and the data line 1142 are disposed between the drain contact 128D of the first switch device SW1 and the drain contact 128D of the second switch device SW2. Additionally, the data line 1141 and the data line 1142 are disposed between the contact hole V3 of the first switch device SW1 and the contact hole V3 of the second switch device SW2. In this embodiment, the range of the first region A1 in the second direction D2 can be from the left edge of the drain contact 128D (the second patterned metal layer 128) of the first switch device SW1 to the right edge of the drain contact 128D (the second patterned metal layer 128) of the second switch device SW2. In short, the first region A1 overlaps the data line 1141, the data line 1142, and the switch devices SW electrically connected to the data lines 1141, 1142 together in this embodiment. In addition, the first region A1 is disposed between two second regions A2, and a third region A3 is disposed at one side of the first region A1. The characteristics of the second regions A2 and the third region A3 in this embodiment are the same as the first embodiment, and they are not redundantly described herein.

The width W1 of the black matrix pattern column 1401 in this embodiment may be 51.8 micrometers for example. Under a circumstance where the black matrix pattern column 1401 equally lies in the regions of the sub-pixel SP4 and the sub-pixel SP5, the widths of portions of the sub-pixel SP4 and the sub-pixel SP5 overlapping with the black matrix pattern column 1401 are about 25.9 micrometers. In this embodiment, the distance between the data line 1141 and the data line 1142 is reduced and the data line 1141 and the data line 1142 are disposed adjoining each other; therefore the adjoining sub-pixels SP4, SP5 in the second direction D2 can be disposed corresponding to one black matrix pattern column 1401. Accordingly, the loss of the aperture ratio of each sub-pixel SP can be reduced, or the number of the black matrix pattern columns 1401 can be reduced. For example, the aperture ratio of each sub-pixel SP in this embodiment is 44.87%. Referring to the comparative example 1 and the comparative example 2 in Table 1, the aperture ratio of each sub-pixel SP in this embodiment is lowered about 22.9% relative to the comparative example 1, and the loss of the aperture ratio of each sub-pixel SP in this embodiment is less than the comparative example 2.

It is noteworthy that the black matrix pattern columns 1401 of the second black matrix layer 140 in the third embodiment of the present disclosure can be replaced by the first black matrix patterns 1561 of the first black matrix layer 156. Each of the first black matrix patterns 1561 is able to simultaneously overlap the data line 1141, the data line 1142, and the switch devices SW electrically connected to the data line 1141 and the data line 1142 in the normal direction V. Accordingly, the aperture ratios can be further improved. Additionally, both of the black matrix pattern columns 1401 and the black matrix pattern rows 1402 of the second black matrix layer 140 can be replaced by the black matrix patterns of the first black matrix layer 156.

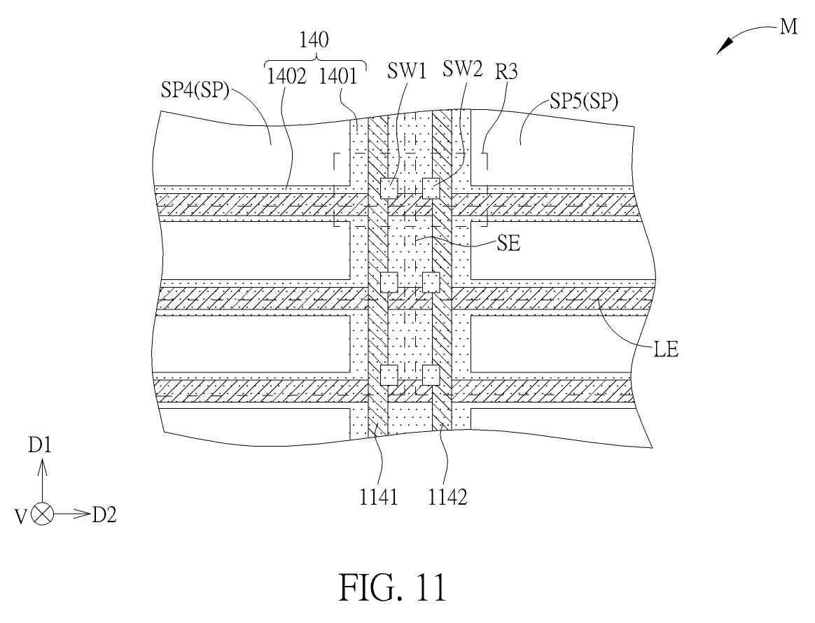

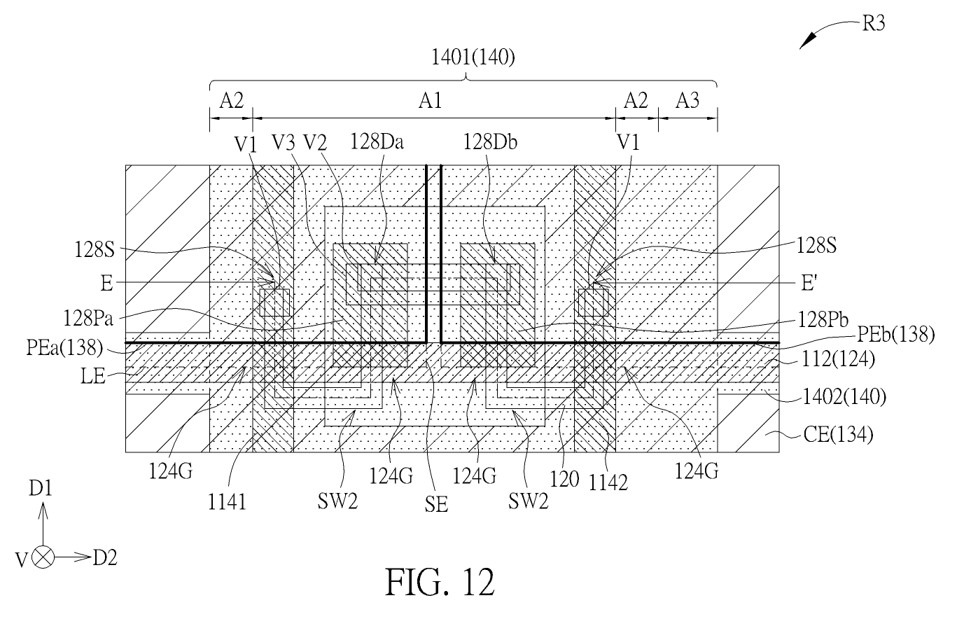

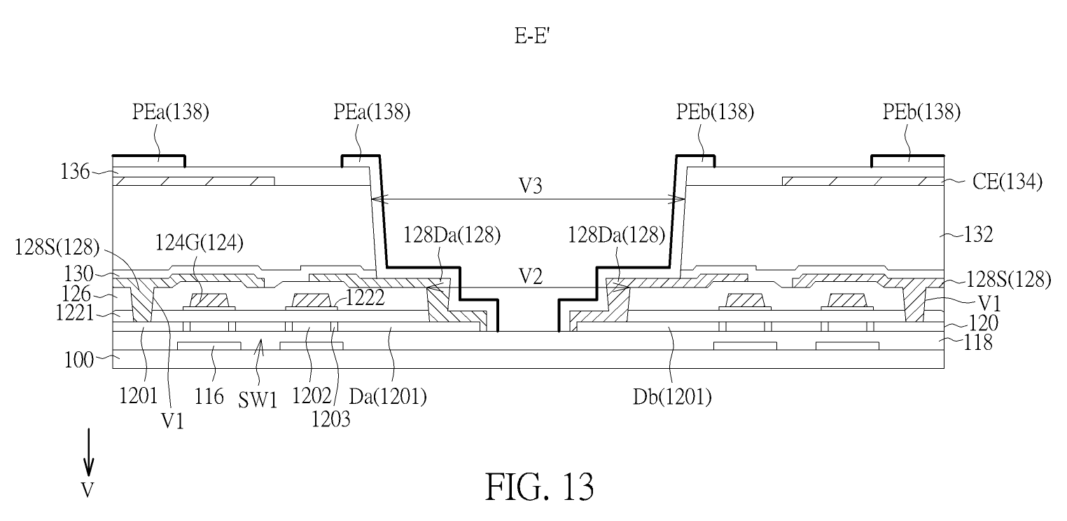

Referring to FIG. 11 to FIG. 13, FIG. 11 is a schematic diagram illustrating a top view of the structure of a portion of sub-pixels of the curved display device according to a fourth embodiment of the present disclosure, FIG. 12 is a schematic diagram illustrating the partial enlargement of a region R3 in FIG. 11, and FIG. 13 is a cross-sectional diagram taken along a line E-E′ in FIG. 12. As shown in FIG. 8 and FIG. 11, one of the differences between the third embodiment and this embodiment is that the first switch device SW1 and the second switch device SW2 are disposed between the data line 1141 and the data line 1142. Additionally, as shown in FIG. 11 and FIG. 12, the shorter edge SE of each sub-pixel SP in this embodiment is aligned with an edge of the corresponding pixel electrode (PEa or PEb) parallel to the first direction D1. The shorter edges SE are aligned with the closest locations of two adjoining pixel electrodes and parallel to the first direction D1 if the pixel electrodes do not include the edges parallel to the first direction D1.

As shown in FIG. 12 and FIG. 13, the first switch device SW1 and the second switch device SW2 share the contact hole V2 and the contact hole V3. The first switch device SW1 includes a first drain Da (one of the heavily doped regions 1201 of the patterned semiconductor layer 120) and a first drain contact 128Da, the second switch device SW2 includes a second drain Db (another one of the heavily doped regions 1201 of the patterned semiconductor layer 120) and a second drain contact 128Db, wherein the first drain contact 128Da extends into the contact hole V2 to electrically connect to the first drain Da, and the second drain contact 128Db also extends into the contact hole V2 to electrically connect to the second drain Db. A gap is disposed between the first drain contact 128Da and the second drain contact 128Db, and therefore the first drain contact 128Da and the first drain Da of the first switch device SW1 can be electrically isolated from the second drain contact 128Db and the second drain Db of the second switch device SW2. In addition, a first pixel electrode PEa extends into the contact hole V3 to electrically connect to the first drain contact 128Da of the first switch device SW1, and a second pixel electrode PEb also extends into the contact hole V3 to electrically connect to the second drain contact 128Db of the second switch device SW2. A gap is disposed between the first pixel electrode PEa and the second pixel electrode PEb, and therefore the first pixel electrode PEa can be electrically isolated from the second pixel electrode PEb.

In this embodiment, the first switch device SW1 and the second switch device SW2 are disposed between the data line 1141 and the data line 1142, and the first switch device SW1 and the second switch device SW2 share the contact hole V2 and the contact hole V3. Areas of a connecting pad 128Pa of the second patterned metal layer 128 of the first switch device SW1 and a connecting pad 128Pb of the second patterned metal layer 128 of the second switch device SW2 can be reduced, or areas of the first switch device SW1 and the second switch device SW2 can be reduced. Accordingly, the width of the black matrix pattern column 1401 or the width of the first region A1 of the black matrix pattern column 1401 can be reduced. In this embodiment, the range of the first region A1 in the second direction D2 can be from the left edge of the data line 1141 to the right edge of the data line 1142. The first region A1 of this embodiment overlaps the data line 1141, the data line 1142, and the switch devices SW electrically connected to the data lines 1141, 1142 together. Additionally, the liquid crystal molecules disposed close to the contact hole V3 are affected by the undulation of the surface underneath and regional light leakage may occur in here. The shared contact hole V3 is disposed between the data line 1141 and the data line 1142 in this embodiment, however; therefore the light leakage region is ensured to be blocked by the black matrix pattern column 1401 or the width of the first region A1 can be reduced. The characteristics of the second regions A2 and the third region A3 of this embodiment are the same as the first embodiment, and they are not redundantly described herein.

For example, the width W1 of the black matrix pattern column 1401 of this embodiment is about 47.8 micrometers. Under a circumstance where the black matrix pattern column 1401 equally lies in the regions of the sub-pixel SP4 and the sub-pixel SP5, the widths of portions of the sub-pixel SP4 and the sub-pixel SP5 overlapping with the black matrix pattern column 1401 are about 23.9 micrometers. For example, the aperture ratio of each sub-pixel SP in this embodiment is 47.29%. Referring to the comparative example 1 and the comparative example 2 in Table 1, the aperture ratio of each sub-pixel SP in this embodiment is lowered about 18.7% relative to the comparative example 1, and the loss of the aperture ratio of each sub-pixel SP in this embodiment is less than the comparative example 2. It is noteworthy that the black matrix pattern columns 1401 of the second black matrix layer 140 in the fourth embodiment of the present disclosure can be replaced by the first black matrix patterns 1561 of the first black matrix layer 156. Each of the first black matrix patterns 1561 is able to simultaneously overlap the data line 1141, the data line 1142, and the switch devices SW electrically connected to the data line 1141 and the data line 1142 in the normal direction V. Accordingly, the aperture ratios can be further improved. Additionally, both of the black matrix pattern columns 1401 and the black matrix pattern rows 1402 of the second black matrix layer 140 can be replaced by the black matrix patterns of the first black matrix layer 156.

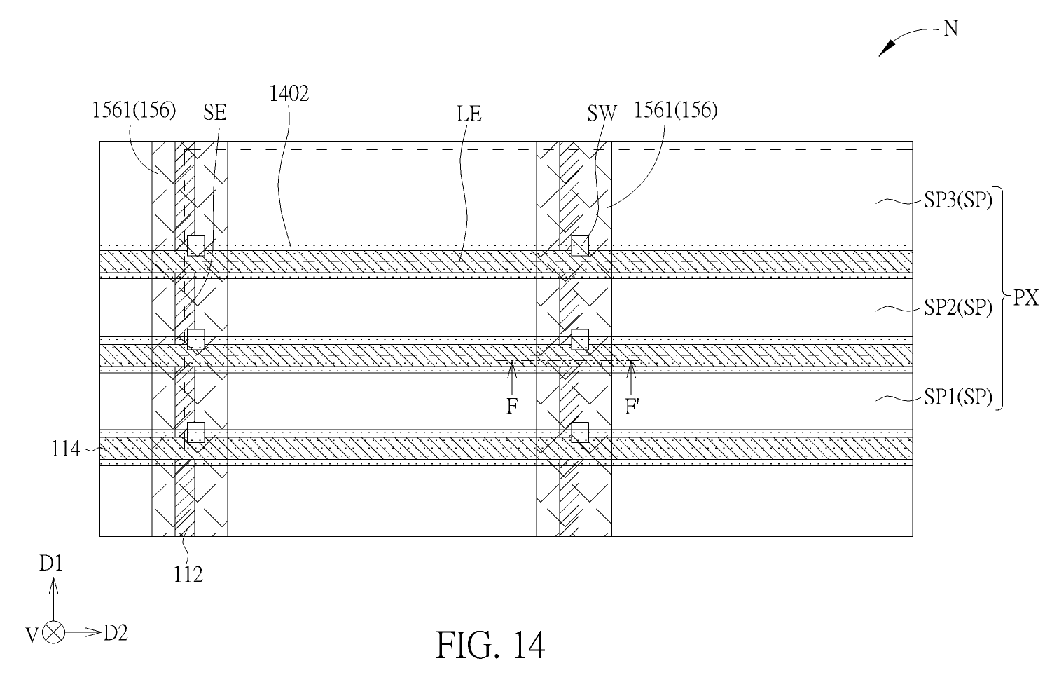

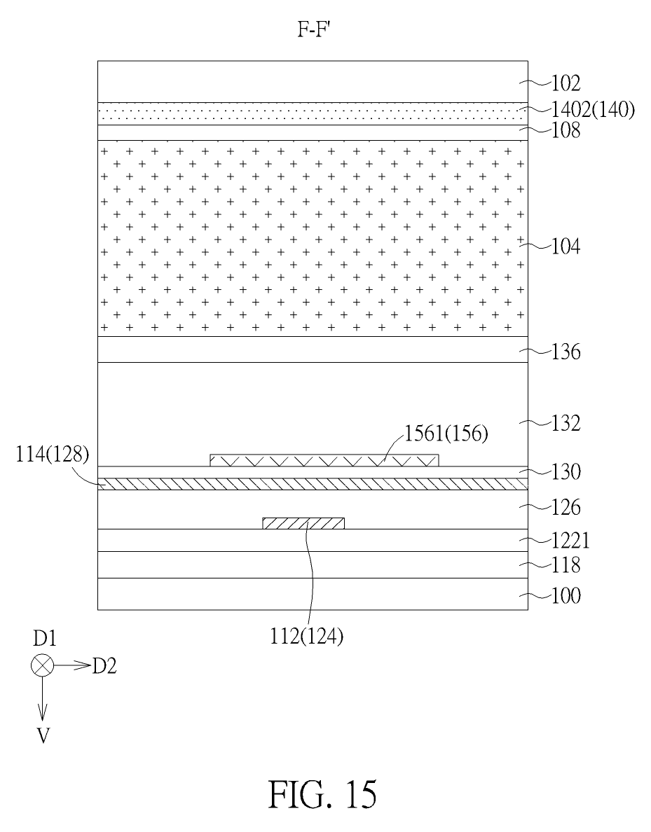

Referring to FIG. 14 and FIG. 15, FIG. 14 is a schematic diagram illustrating a top view of the structure of a portion of sub-pixels of the curved display device according to a fifth embodiment of the present disclosure, and FIG. 15 is a cross-sectional diagram taken along a line F-F′ in FIG. 14. As shown in FIG. 14, one of the differences between the first embodiment and this embodiment is that the scan lines 112 extend in the first direction D1, and the data lines 114 extend in the second direction D2. The scan lines 112 are parallel to the bending axis 12 and the data lines 114 are perpendicular to the bending axis 12, but this is not limited thereto. In a pixel PX, each of the first sub-pixel SP1, the second sub-pixel SP2, and the third sub-pixel SP3 is electrically connected to one data line 114, and the first sub-pixel SP1, the second sub-pixel SP2, and the third sub-pixel SP3 are all electrically connected to the same scan line 112. In short, one pixel PX corresponds to three data lines 114 and one scan line 112.

In addition, as shown in FIG. 14 and FIG. 15, each of the first black matrix patterns 1561 extends along one of the scan lines 112 and overlaps the corresponding scan line 112 in the normal direction V in the portion N of the display region DR in this embodiment, wherein the extending direction of the first black matrix patterns 1561 is parallel to the bending axis 12. The first black matrix layer 156 forming the first black matrix patterns 1561 is disposed between the second insulating layer 130 and the third insulating layer 132 in this embodiment, but this is not limited thereto. In other embodiments, the first black matrix layer 156 may be disposed between the fourth insulating layer 136 and the display medium layer 104. In addition, each of the data lines 114 can be overlapped by one of the black matrix pattern rows 1402 of the second black matrix layer 140, but this is not limited thereto. In other embodiments, the black matrix patterns overlapping the data lines 114 in the portion N can be formed of the first black matrix layer 156. In this embodiment, the first black matrix patterns 1561 and the corresponding scan lines 112 or switch devices SW are all disposed on the first substrate 100. Therefore, the misalignments between the first black matrix patterns 1561 and the corresponding scan lines 112 or switch devices SW in the second direction D2 can be effectively reduced after the curved display panel 10 is bent. Additionally, the phenomenon of poor uniformity of the aperture ratios of the sub-pixels SP or Mura caused by the exposed scan lines 112 can be effectively reduced after the curved display panel 10 is bent.

It should be noted that the technical features in different embodiments described in the above may be replaced, recombined, or mixed with one another to constitute another embodiment without departing from the spirit of the present disclosure.

To summarize the above descriptions, the longer edge of each sub-pixel is perpendicular to the bending axis, and the black matrix pattern columns are parallel to the shorter edges of the sub-pixels in the curved display panel of the present disclosure. Therefore, the loss of the aperture ratio of each sub-pixel can be reduced when the width of the black matrix pattern columns is increased. The reduction of the number of data lines parallel to the bending axis reduces the loss of the overall aperture ratio of the display region when the width of the black matrix pattern columns is increased. The reduction of the distance of two adjoining data lines enables two adjoining sub-pixel to share one black matrix pattern column. Accordingly, the loss of the aperture ratio of each sub-pixel can be reduced, or the number of the black matrix pattern columns can be reduced. The sub-pixels are arranged in a plurality of sub-pixel rows, the sub-pixel rows extend in the second direction (perpendicular to the bending axis), and the sub-pixels in the same sub-pixel row display the same color. Accordingly, even when the black matrix pattern columns cannot completely block the light from the adjacent sub-pixels when the black matrix pattern columns 1401 shift relative to the corresponding data lines in the second direction, the phenomenon of color mixing can still be prevented when the user is obliquely viewing the curved display panel from the second direction. The reduction of the number of data lines parallel to the bending axis can reduce the width of the peripheral region or the width of the border frame of the curved display panel. The spacers are disposed corresponding to the black matrix pattern columns, and the loss of the aperture ratios of the sub-pixels caused by disposing the spacers can be reduced. In addition, the first black matrix patterns and the corresponding first metal lines (e.g. the data lines or the scan lines) or switch devices can all be disposed on the surface of the first substrate, thus the misalignments between the first black matrix patterns and the corresponding first metal lines or switch devices in the second direction can be effectively reduced. Additionally, the phenomenon of poor uniformity of the aperture ratios of the sub-pixels or Mura caused by the exposed first metal lines can be effectively reduced.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A curved display panel comprising a bending axis parallel to a first direction, comprising:
a first substrate;
a plurality of sub-pixels disposed on the first substrate, wherein each of the sub-pixels includes a longer edge and a shorter edge, the shorter edge is parallel to the first direction, the longer edge is parallel to a second direction, and the first direction and the second direction are not parallel;
a plurality of first metal lines disposed on a surface of the first substrate and extending in the first direction, wherein each of the sub-pixels is disposed corresponding to one of the first metal lines; and
a first black matrix layer disposed on the surface of the first substrate, the first black matrix layer overlapping the first metal lines in a normal direction of the surface of the first substrate.

2. The curved display panel of claim 1, wherein the sub-pixels are arranged in a plurality of sub-pixel rows extending in the second direction, and a plurality of sub-pixels in one of the sub-pixel rows display the same color.

3. The curved display panel of claim 1, further comprising:
a second substrate, wherein the second substrate is disposed opposite to the first substrate; and
a display medium layer disposed between the second substrate and the first substrate;
wherein the first black matrix layer is disposed between the display medium layer and the first substrate.

4. The curved display panel of claim 3, further comprising:
a plurality of second metal lines disposed on the surface of the first substrate and extending in the second direction, wherein each of the sub-pixels is disposed corresponding to one of the second metal lines; and
a second black matrix layer disposed between the display medium layer and the second substrate;
wherein the second black matrix layer overlaps the second metal lines in the normal direction.

5. The curved display panel of claim 1, wherein each of the sub-pixels comprises a switch device, the sub-pixels comprise a first sub-pixel, a second sub-pixel, and a third sub-pixel configured to display different colors, the first sub-pixel, the second sub-pixel, and the third sub-pixel are disposed adjoining each other in the first direction, and a switch device of the first sub-pixel, a switch device of the second sub-pixel, and a switch device of the third sub-pixel are electrically connected to one of the first metal lines.

6. The curved display panel of claim 1, wherein the first black matrix layer comprises a plurality of first black matrix patterns extending in the first direction, and one of the first black matrix patterns overlaps two adjoining first metal lines in the normal direction.

7. The curved display panel of claim 6, wherein each of the sub-pixels comprises a switch device, one of the two adjoining first metal lines is electrically connected to a first switch device of a corresponding sub-pixel of the plurality of sub-pixels, another one of the two adjoining first metal lines is electrically connected to a second switch device of a corresponding sub-pixel of the plurality of sub-pixels, and the first switch device and the second switch device are disposed between the two adjoining first metal lines.

8. The curved display panel of claim 7, wherein the first switch device comprises a first drain and a first drain contact, the second switch device comprises a second drain and a second drain contact, the first drain contact extends into a first contact hole to electrically connect to the first drain, and the second drain contact extends into the first contact hole to electrically connect to the second drain.

9. The curved display panel of claim 8, wherein the first switch device further comprises a first pixel electrode, the second switch device further comprises a second pixel electrode, the first pixel electrode extends into a second contact hole to electrically connect to the first drain contact, and the second pixel electrode extends into the second contact hole to electrically connect to the second drain contact.

10. The curved display panel of claim 6, wherein each of the sub-pixels comprises a switch device, one of the two adjoining first metal lines is electrically connected to a first switch device of a corresponding sub-pixel of the plurality of sub-pixels, another one of the two adjoining first metal lines is electrically connected to a second switch device of a corresponding sub-pixel of the plurality of sub-pixels, and the two adjoining first metal lines are disposed between the first switch device and the second switch device.

11. A curved display panel comprising a bending axis parallel to a first direction, comprising:
a first substrate;
a second substrate;
a plurality of sub-pixels disposed on the first substrate, wherein each of the sub-pixels includes a longer edge and a shorter edge, the shorter edge is parallel to the first direction, the longer edge is parallel to a second direction, and the first direction and the second direction are not parallel;
a plurality of first metal lines disposed on a surface of the first substrate and extending in the first direction, wherein each of the sub-pixels is disposed corresponding to one of the first metal lines; and
a first black matrix layer disposed between the first substrate and the second substrate, wherein the first black matrix layer comprises a plurality of first black matrix patterns extending in the first direction, and one of the first black matrix patterns overlaps two adjoining first metal lines in the normal direction.

12. The curved display panel of claim 11, wherein each of the sub-pixels comprises a switch device, one of the two adjoining first metal lines is electrically connected to a first switch device of a corresponding sub-pixel of the plurality of sub-pixels, another one of the two adjoining first metal lines is electrically connected to a second switch device of a corresponding sub-pixel of the plurality of sub-pixels, and the first switch device and the second switch device are disposed between the two adjoining first metal lines.

13. The curved display panel of claim 12, wherein the first switch device comprises a first drain and a first drain contact, the second switch device comprises a second drain and a second drain contact, the first drain contact extends into a first contact hole to electrically connect to the first drain, and the second drain contact extends into the first contact hole to electrically connect to the second drain.

14. The curved display panel of claim 13, wherein the first switch device further comprises a first pixel electrode, the second switch device further comprises a second pixel electrode, the first pixel electrode extends into a second contact hole to electrically connect to the first drain contact, and the second pixel electrode extends into the second contact hole to electrically connect to the second drain contact.

15. The curved display panel of claim 11, wherein each of the sub-pixels comprises a switch device, one of the two adjoining first metal lines is electrically connected to a first switch device of a corresponding sub-pixel of the plurality of sub-pixels, another one of the two adjoining first metal lines is electrically connected to a second switch device of a corresponding sub-pixel of the plurality of sub-pixels, and the two adjoining first metal lines are disposed between the first switch device and the second switch device.

16. The curved display panel of claim 11, wherein the sub-pixels are arranged in a plurality of sub-pixel rows extending in the second direction, and a plurality of sub-pixels in one of the sub-pixel rows display the same color.

17. The curved display panel of claim 11, further comprising:
a display medium layer disposed between the second substrate and the first substrate;
wherein the first black matrix layer is disposed between the display medium layer and the first substrate.

18. The curved display panel of claim 17, further comprising:
a plurality of second metal lines disposed on the surface of the first substrate and extending in the second direction, wherein each of the sub-pixels is disposed corresponding to one of the second metal lines; and
a second black matrix layer disposed between the display medium layer and the second substrate;
wherein the second black matrix layer overlaps the second metal lines in the normal direction.

19. The curved display panel of claim 11, wherein each of the sub-pixels comprises a switch device, the sub-pixels comprise a first sub-pixel, a second sub-pixel, and a third sub-pixel configured to display different colors, the first sub-pixel, the second sub-pixel, and the third sub-pixel are disposed adjoining each other in the first direction, and a switch device of the first sub-pixel, a switch device of the second sub-pixel, and a switch device of the third sub-pixel are electrically connected to one of the first metal lines.
